(19) United States
(12) Patent Application Publication
(10) Pub. No.: US 2018/0018571 A1
(43) Pub. Date: Jan. 18, 2018

(54) SYSTEM AND METHOD FOR USING ARTIFICIAL INTELLIGENCE IN MAKING DECISIONS

(71) Applicant: QUORUM.AI INC., San Francisco, CA (US)

(72) Inventor: Noah Z. Schwartz, Alameda, CA (US)

(21) Appl. No.: 15/548,508

(22) PCT Filed: Feb. 4, 2016
(86) PCT No.: PCT/US16/16644

§ 371 Date: Aug. 3, 2017

Related U.S. Application Data
(60) Provisional application No. 62/113,361, filed on Feb. 6, 2015.

(51) Int. Cl. G06N 5/04

(52) U.S. Cl. CPC G06N 5/04

(57) ABSTRACT

A computer implemented method is disclosed of providing an artificial intelligence architecture for controlling data and performing decisions relating to an object and/or an environment of the object. The method comprises executing on one or more processors the steps of: processing data from one or more sensors to identify first and second states of the object and/or the object's environment; analyze the first state and second state of the object and/or the object's environment to discover an apparent causal relationship between the first and second states of the environment; and making a change to the data relating to an object and/or the object's environment based on the apparent causal relationship to affect subsequent states of the object and/or the object's environment.

### CROSS-REFERENCE TO RELATED APPLICATIONS

This application claims priority to U.S. provisional application No. 62/113,361, filed Feb. 6, 2015, which is incorporated by reference herein.

### FIELD OF THE INVENTION

The present invention relates to a system and method for using artificial intelligence in making decisions.

### BACKGROUND OF THE INVENTION

Artificial intelligence (Al) has received quiet a bit of attention in the past several years. The industry is pursuing Al in several fields such as neural networks, robotics, image recognition, expert systems (decision support and teaching systems), speech processing, natural language processing and machine learning (to name a few). Unfortunately, current Al systems require extensive data training that must be carefully curated by data scientists to be useful. If retraining is required, the Al system must be taken offline and reset in order to accommodate any new data.

It would therefore be advantageous to have a system that overcomes the disadvantages above with respect to the current Al systems.

### SUMMARY OF THE INVENTION

In accordance with an embodiment of the present disclosure, a system and method are disclosed for using artificial intelligence in making decisions.

In accordance with an embodiment of the present disclosure, a computer implemented method is disclosed of providing an artificial intelligence architecture for controlling data and performing decisions relating to an object and/or an environment of the object. The method comprises executing on one or more processors the steps of processing data from one or more sensors to identify first and second states of the object and/or the object's environment, analyze the first state and second state of the object and/or the object's environment to discover an apparent causal relationship between the first and second states of the environment; and making a change to the data relating to an object and/or the object's environment based on the apparent causal relationship to affect subsequent states of the object and/or the object's environment.

In accordance with another embodiment of the present disclosure, a system is disclosed for providing an artificial intelligence architecture for controlling data and performing decisions relating to an object and/or an environment of the object. The system comprise (a) a data store to storing data relating to an object and/or the object's environment, and (b) one or more processors coupled to the data store and programmed to (i) process data from one or more sensors to identify first and second states of the object and/or the object's environment, (ii) analyze the first state and second state of the environment to discover an apparent causal relationship between the first and second states of the environment; and make a change to the data relating to an object and/or the object's environment based on the causal relationship to affect subsequent states of the object and/or the object's environment.

In accordance with yet another embodiment of the present disclosure, a system disclosed for using artificial intelligence in making decisions with respect to an object or the environment of the object. The system comprises (1) a data store for storing data relating to an object and/or the object's environment and (2) memory for storing a plurality of modules and one or more processors coupled the data store and the memory for executing a plurality of modules, the plurality of modules comprising, a sensory processing engine for processing data from one or more sensors to identify first and second states of an environment, and a causality engine for (1) identifying an apparent causal relationship between the first state and the second state and (2) making a change to affect subsequent states of the object and/or the object's environment.

### BRIEF DESCRIPTION OF THE DRAWINGS

FIG. 1 depicts a block diagram of an example system for using artificial intelligence for making decisions.

FIG. 2 depicts a high-level flow diagram of the method steps of the system shown in FIG. 1.

FIG. 3 depicts a detailed flow diagram of the method steps of the sensory pre-processing engine (and effector grammar engine) shown in FIG. 1.

FIG. 4 depicts a detailed flow diagram of the method steps of the casualty engine shown in FIG. 1.

FIG. 5 depicts an example system incorporating the architecture in FIG. 1 depicting the salient hardware components.

FIG. 6 depicts example system that incorporates the architecture in FIG. 1.

FIG. 7 depicts another example that incorporates the architecture in FIG. 1.

### DETAILED DESCRIPTION OF THE INVENTION

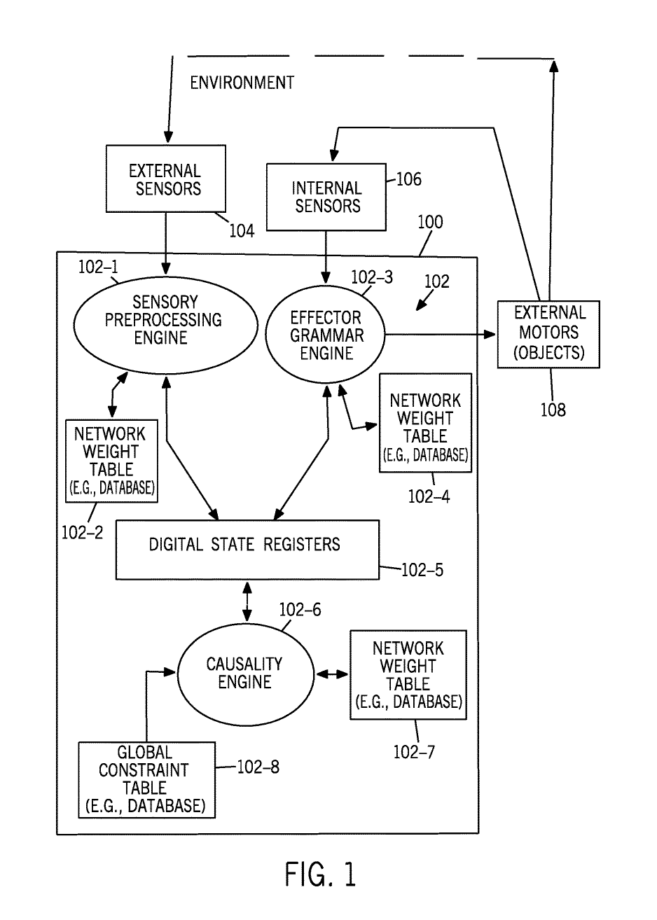

FIG. 1 depicts a block diagram of example system 100 for using artificial intelligence in making decisions. Specifically, system 100 provides (incorporates) artificial intelligence architecture 102 that provides a mechanism or engine (i.e., platform) for making such decisions. In other words, system 100 provides an environment in which artificial intelligence architecture 102 operates. These decisions may be made on all types of objects (as described below) in all types of environments of those objects, using any type of data. In operation (in brief), system 100 (and hence architecture 102) is adapted to receive data parameters from a central source or distributed sources relating to an object and/or its environment, recognize complex patterns and temporal sequences of patterns within such data parameters (i.e., learns patterns and anticipates) and make changes to modify the data parameters as a means of controlling the object and/or its environment. (Note that the term “data” and “data parameters” may be used interchangeably in this application.)

In the embodiment shown in FIG. 1, architecture 102 is configured to control the motion or manipulation of a connected object or objects. Specifically, architecture 102 is configured to perform tasks relating to object movement and navigation including localization (i.e., knowing where the object is located or finding out where other objects are located external to system 100). Architecture 102 may also be configured to perform other tasks relating to an object as a whole such as (1) mapping (i.e., learning what is around the object), (2) motion planning (i.e. figuring out how to get somewhere) and/or (3) path planning (i.e., going from one point in space to another point, which may involve compliant motion—where the object moves while maintaining physical contact with another object). In this embodiment, the connected objects are a set of external motors 108. This is described in more detail below. However, those skilled in the art know that a connected object includes any physical, non-physical, stationary and/or non-stationary entities. For example, an object may be data sources (i.e., databases), data channels (such as data received from another computer), or other data-centric concepts (to name a few). Music and text are examples of objects described herein.

While architecture 102 is described with respect to a single connected object in FIG. 1, architecture 102 may be used to receive, recognize and control data parameters simultaneously from multiple objects and other types of environmental data parameters. For example, architecture 102 may be configured to recognize and control data relating to text, sound or any other data that exhibit a pattern expressed over time. In processing and recognizing these patterns, architecture 102 will learn the likelihood that one event (i.e., change in states, as discerned from the data parameters) caused a second event, and what event leads to another event over time. Regardless of the intended decision made by system 100, the operation of architecture 102 is performed autonomously. Supervised or guided training is not needed. This is described in more detail below.

Returning to FIG. 1, architecture 102 includes sensory pre-processing engine 102-1 with associated network weight table 102-2, effector grammar engine 102-3 with associated network weight table 102-4, digital state registers 102-5, causality engine 102-6 with associated network weight table 102-7 and global constraint table 102-8. Sensory pre-processing engine 102-1 communicates with (as shown connected to) network weight table 102-2, digital state registers 102-5 and external sensors 104. Effector grammar engine 102-3 communicates with (as shown connected to) network weight table 102-4, digital state registers 102-5 and internal sensors 106. Causality engine 102-6 communicates with (as shown connected to) digital state registers 102-5, network weight table 102-7 and global constraint table 102-8. In the current embodiment, external sensors 104 and internal sensors 106 are connected to system 100 (and sensory pre-processing engine 102-1 and effector grammar engine 102-3). External sensors 104 collect and relay data regarding the state of the environment around system 100 such as external motors 108 and/or their environment. Internal sensors 106 collect and relay data regarding the state of system 100, such as the state of external motors 108 as described below.

In the embodiment in FIG. 1, system 100 incorporates at least one or more processors and memory to implement architecture 102 (i.e., its software modules/instructions, registers, databases etc.). The one or more processors and memory may be part of a single computer board or card or may be distributed within a server or several servers connected to each other via a network. This is described in more detail below (with examples).

External sensors 104, as known to those skilled in the art, are sensors that sense data relating to measurable characteristics of an environment including materials in the environment (e.g., an object or thing). The sensors may generate data from an infrared device, button depression, or voltage or electrical current, etc. Sensors 104 are typically hardware components but may be implemented through software, or by relaying the state of a variable defined in software.

Internal sensors 106, as known to those skilled in the art, generate data relating to the physical state of an environment (e.g., object) such as the location of the object, activation status of the object, etc. In the embodiment in FIG. 1, internal sensors 106 sense data relating to motors 108 (objects) such as the speed, temperature, or location of motors 108 or whether they are activated. Sensors 106 are also typically hardware components, but may be implemented through software or by relaying the state of a variable defined in software as known to those skilled in the art.

Sensory preprocessing engine (SPE) 102-1 is a software module or set of processor instructions that processes received data to identify the status or states of an environment (e.g., an object or thing not connected to system 100). For example, if the input to SPE 102-1 from sensors 104 is a camera, the SPE 102-1 processes luminance or chromaticity data distributed over space (i.e., spatial information). If the input data to SPE 102-1 is from a microphone, SPE 102-1 processes sound into frequency data (i.e., temporal information). If the input data to SPE 102-1 is from a text-based or language-based source, SPE 102-1 processes data into categorical or semantic information. Other examples of the processed data include the location, type or nature of the object or thing being sensed. In the embodiment in FIG. 1, the processed data relates to characteristics intrinsic to the external environment as well as secondary effects of the external motors 104 (or any connected object) operating on the external environment. The data is sent to the digital state registers 102-5 (for storage) and subsequent use and processing. SPE 102-1 processes the data using any type of encoding method known to those skilled in the art, such as a look-up table, rescaling function, single-layer or multi-layer classification network, or pattern-recognition algorithm, including a recurrent, auto-associative, or similar neural network defined by its own architecture and associated weight table (weight table 102-2) as desired.

Network weight table (NWT) 102-2 is a stored table comprising all of the parameters describing how data is transformed and controlled during the decision making process of architecture (platform) 102. The data will be assigned weights used in the decision making process of architecture (platform) 102, but such data will be modified during the process depending on the gathered and analyzed weighted data. For example, the table may include likelihood statistics that are estimated from received data. The data in NWT 102-2 may be in the form of a database or other data structure.

Effector grammar engine (EGE) 102-3 is a software module or set of processor instructions that processes received data (information) from the internal state sensors 106. EGE 102-3 functions similarly as SPE 102-1 but EGE 102-3 possesses certain knowledge about connected objects operating in the environment such as the type or nature of the object or thing. For example, EGE 102-3 is aware that the object is a motor and its rotation. EGE 102-3 processes the data using any type of encoding method known to those skilled in the art, such as a look-up table, rescaling function, single-layer or multi-layer classification network, or pattern-recognition algorithm, including a recurrent, auto-associative, or similar neural network defined by its own architecture and associated weight table (weight table 102-4) as desired. EGE 102-3 ultimately monitors and changes the state of the connected object under examination (e.g., an object or thing) based on data within digital state registers 102-3 and data received from internal sensors 106 in order to satisfy constraints that are defined elsewhere in the system. SPE 102-1 and EGE 102-3 do not directly communicate with each other.

Network weight table 102-4 is a stored table comprising all of the parameters describing how data is transformed and controlled during the decision making process of architecture (platform) 102. The data will be assigned weights used in the decision making process of architecture (platform) 102, but such data will be modified during the process depending on the gathered and analyzed weighted data. For example, the table may include likelihood statistics that are estimated from received data. The data in NWT 102-4 may be in the form of a database or other data structure.

Digital state registers (DSR) 102-3 hold (i.e., store) data parameters and makes them available for other logic elements for computing processes. DSR 102-3 receives state parameters (a report) relating to the environment as determined by SPE 102-1 and EGE 102-3. The states in DSR 102-3 will be changing constantly. DSR 102-3 may be implemented in hardware or software as known to those skilled in the art.

Causality engine (CE) 102-6 is a software module or set of processor instructions for monitoring when the states occur at different points in time and determines the apparent likelihood that each event (i.e., change in state) caused subsequent events. CE 102-6 employs any type of recurrent Bayesian likelihood estimator or temporal difference learning algorithm to make this determination. As known to those skilled in the art, these algorithms observe and process events over time and estimate the likelihood that a specific event will occur given evidence that other events have occurred. CE 102-6 applies these algorithms to all data in the digital state registers independent of any performance or training goals, reinforcement, or operating constraints present in system 100. CE 102-6 uses these statistics to determine apparent causal relationships between events in the digital state registers. CE 102-6 then uses the user-defined constraints within global constraint table 102-8 to assign a benefit or cost to perceived events. By applying this algorithm recurrently, CE 102-6 predicts when positive or negative events are expected to occur given the current and predicted trajectory of events in DSR 102-5. CE 102-6 then identifies alternate states that will result in either a reduced predicted cost or increased predicted benefit. These alternate states are projected into DSR 102-5 which then relays them as control instructions to EGE 102-2, directing it to take steps to pursue beneficial states and avoid costly states of the environment (i.e., prevent those events from occurring).

The separation of SPE 102-1 and EGE 102-3 from CE 102-6 allows CE 102-6 to estimate the likelihood that discrete, internally generated activity will affect the external environment. This gives system 100 the ability to learn how any connected object (i.e. external motors 108) may be used to intentionally manipulate the environment to achieve the goals of system 100, as defined by global constraint table 102-8.

Global constraint table (GCT) 102-8 stores user-defined or computer-generated goals that are used as constraints for CE 102-6. Computer-generated goals may be derived using any method known to those skilled in the art, such as genetic algorithms. Goals are defined as costs (positive and negative) for all digital states and are stored as constraints. For example, if the state of an accelerometer receives a rapid jarring input, this could have a high cost (like dropping on floor). In another example, a low battery would be a high cost and a full battery is a low cost. GCT 102-8 may be in the form of a database or other data structure.

Network weight table (NWT) 102-7 is a stored table comprising all of the probabilities that CE 102-6 has learned over time. The data will be assigned weights used in the decision making process of architecture (platform) 102, but such data will be modified during the process depending on the gathered and analyzed weighted data. For example, the table includes the likelihood that event A appears to cause event B. For all events that are recorded by DSR 102-5, the table stores the likelihood that any event appears to cause any other event. The data in NWT 102-7 may be in the form of a database or other data structure.

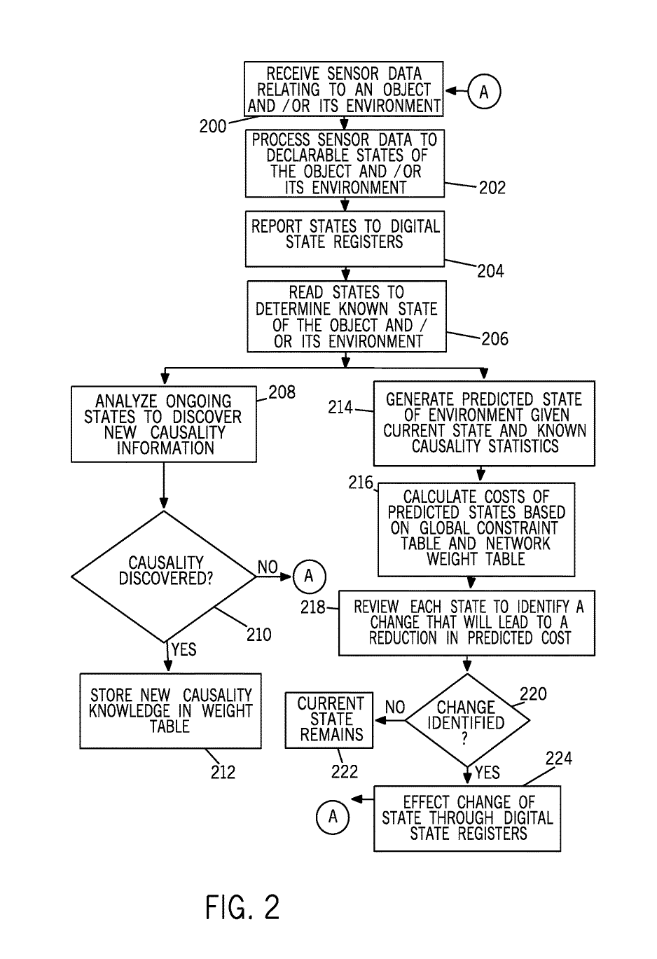

FIG. 2 depicts an example high-level flow diagram of the method steps of system 100 shown in FIG. 1. The steps in FIG. 2 represent a loop (of steps 200-224) that continuously repeats as described below. (The method steps are described with respect to one object but is may apply to any number objects, e.g., as shown in FIG. 1.)

Execution begins at step 200 wherein SPE 102-1 receives sensor data from external sensors 104 relating to an object and/or its environment. Execution moves to step 202 wherein the sensor data is processed to establish identifiable or declarable states of the object and/or its environment. These established states are reported to (and stored in) the DSR 102-5 at step 204.

Execution moves to step 206 wherein the states in the DSR 102-5 are read and processed in CE 102-6 to establish the current (known) state of the object and/or its environment. Processing in the CE 102-6 then branches into two sub-processes illustrated in steps 208-212 and steps 214-224.

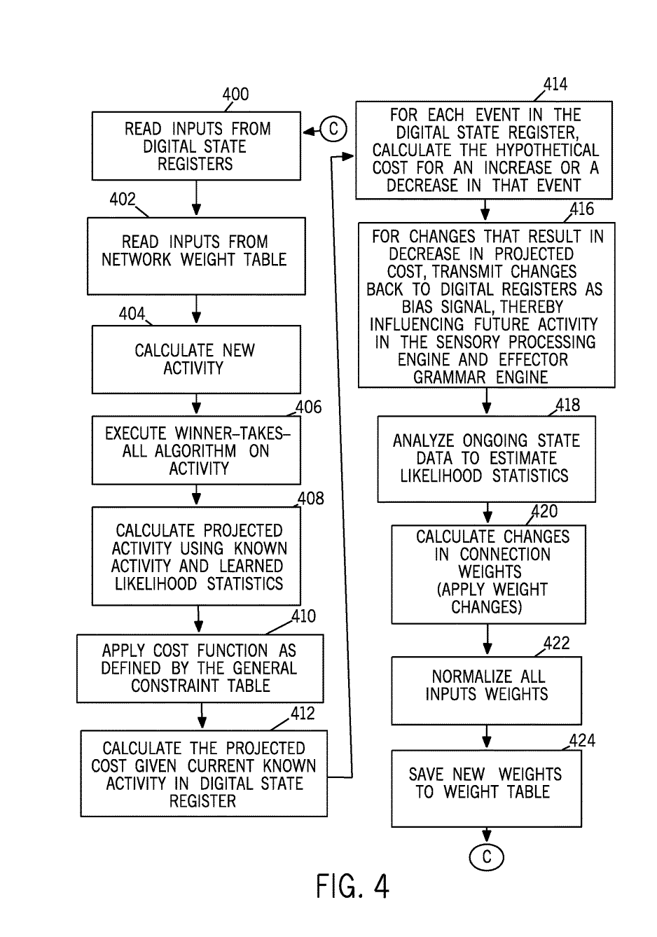

Steps 208-212 entail the analysis and knowledge discovery functions of CE 102-6, illustrated in more detail in FIG. 4. In step 208, CE 102-6 will determine if one event (represented through the values in DSR 102-5) appears to precede or to cause another event (also represented through the values in DSR 102-5). If new apparent causality knowledge is discovered at decision step 210, it is stored in the NWT 102-7 at step 212. Steps 208-210 process all states in DSR 102-5 on an ongoing basis, storing new causality knowledge as it is discovered.

Steps 214-224 represent the prediction and decision functions of CE 102-6. Output from step 206 is processed by CE 102-6 in step 214 wherein known causality statistics in NWT 102-7 are applied to the current state of system 100 to generate a predicted state of the environment.

Execution then moves to step 216 wherein the costs of the predicted states are calculated based on GCT 102-8 and NWT 102-7. For example, if state A is predicted to occur as determined in step 214, and state A is defined in GCT 102-8 as having a negative cost, then the cost of the predicted state will reflect this negative cost. The aggregate cost of all states may be defined as a weighted or unweighted sum of all predicted costs.

Execution then moves to steps 218-224 wherein CE 102-6 identifies changes in state (i.e., alternate states) that yield a lower cost than the predicted cost calculated at step 216. Specifically, at step 218, each state is reviewed to identify a change that will lead to a reduction in predicted cost. If any changes in state (alternate states) are identified at decision step 220, they will be projected back into DSR 102-5 at step 224 to be received by EGE 102-3 as control signals. If no changes in states (i.e., alternate states) are identified, or if the predicted state represents the lowest-possible-cost future, then no information is projected back onto DSR 102-5 and system 100 is allowed to continue on its current trajectory as step 222.

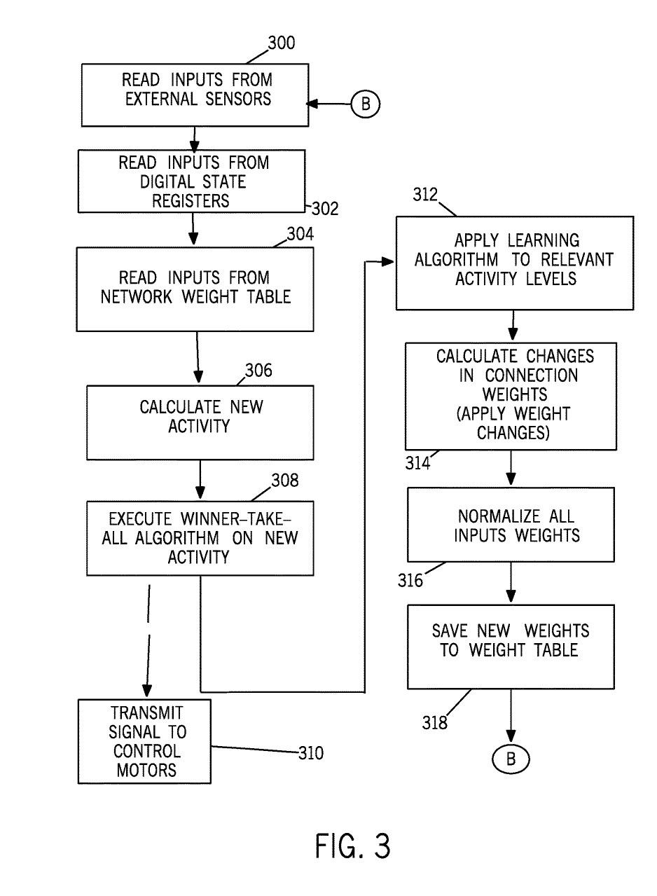

FIG. 3 depicts a detailed flow diagram of the method steps of SPE 102-1 and EGE 102-3 shown in FIG. 1. Flow will be described with respect to SPE 102-1, but the same method steps apply to EGE 102-3 unless stated otherwise. The steps in FIG. 3 represent a loop (of steps 300-318) that continuously repeats as described below.

For SPE 102-1, execution begins at steps 300 and 302 wherein the inputs from the external sensors 104 (relating to the object and/or its environment as described with respect to FIG. 1), DSR 102-5 and any inputs from auto-associative connections or sub-layers within SPE 102-1 (as defined in associated network weight table 102-2) are read. For EGE 102-3, inputs from internal sensors 106, DSR 102-5 and any auto-associative connections or sub-layers within EGE 102-3 (as defined in associated network weight table 102-4) are read at step 304.

Execution proceeds to step 306 wherein new activity is calculated based on the input parameters and weight table parameters. As known to those skilled in the art, this process may be replaced with any type of signal processing algorithm that receives and transforms input from one or more data sources. This signal processing algorithm may be terminal or recurrent.

Execution proceeds to step 308 wherein a winner-take-all (WTA) algorithm is executed on the result of step 306, per input dimension. For the purpose of this step, each internal sensor 106 (or in EGE 102-3, each attached object) represents a separate dimension of activity (i.e., separate sources of data). Any winner-take-all algorithm known to those skilled in the art may be applied to each dimension in order to reduce noise or competition among mutually exclusive states, allowing for a single, dominant state to be magnified relative to weaker states. Functionally, the WTA algorithm is applied to all states within a given dimension, increasing the activity associated with the strongest state and decreasing the activity associated with weaker states (hence winner takes all). As known by those skilled in the art, the strength of the WTA algorithm may vary from none to one-step suppression, depending on the level of tolerance desired. (With respect to the process flow of EGE 102, execution proceeds to step 310 (dashed lines) wherein a signal representing the result of the WTA algorithm is transmitted to external motors 108 to change a parameter or more and control such motors.) Execution simultaneously continues to step 312 with respect to EGE 102-3 as described below. Otherwise execution moves directly from step 308 to step 312 with respect to SPE 102-1 as described below.)

If the SPE 102-1 or EGE 102-3 employs any learning algorithm or dynamic functionality, network weight tables (102-2 and 102-4, respectively) may be modified in steps 312-318. Learning algorithms may include supervised or unsupervised methods, including any form of gradient descent, back propagation, or convolutional techniques, for example. In other embodiments of system 100, SPE 102-1, however, may be pre-trained and used without any further weight changes initiated by system 100. In this respect, other learning algorithms and architectures such as deep learning, deep belief networks, or restricted Boltzmann networks may be used as known to those skilled in the art.

An example of the use of a learning algorithm is illustrated in FIG. 3 in steps 312-318. Following completion of steps 308 and 310, execution then moves to step 312 wherein activity levels are processed according to the learning algorithm being used.

Execution proceeds to step 314 where changes in the connection weights are calculated. If there is no other activity processing in the loop in FIG. 3, then the weights remain the same. However, if there is new activity through a loop of the method steps in FIG. 3, then the state has changed (no decay) and the weight will change accordingly.

The input weights are then normalized or pruned at step 316 according to the learning algorithm being used and saved in the network weight table at step 318. Those skilled in the art know that there are a number of ways to accomplish this such as applying a sparsity constraint as in restricted Boltzmann networks, enforcing a minimum viable network weight and reducing all weights to 0 that fail to meet the minimum, or dividing all weights by some constant so that they sum to 1.

FIG. 4 depicts a detailed flow diagram of the method steps of CE 102-6 shown in FIG. 1. These method steps proceed in a loop that continuously repeats. The method steps are as follows.

Execution begins at steps 400 and 402 wherein inputs from DSR 102-5 and NWT 102-7, respectively. Execution proceeds to step 404 wherein new activity is calculated based on the input parameters and weight table parameters. This defines a multi-dimensional state of the object and/or its environment in which each sensor and effector channel in the DSR 102-5 is defined as a separate dimension. Aggregate activity across all dimensions defines the complete environment insofar as CE 102-6 is concerned.

Execution proceeds to step 406 wherein a winner-take-all (WTA) algorithm is executed on the new activity per dimension. Any WTA algorithm known to those skilled in the art may be applied to each dimension to reduce noise or competition among mutually exclusive states, allowing for a single, dominant state to be magnified relative to weaker states. Functionally, the WTA algorithm is applied to all states within a given dimension, increasing the activity associated with the strongest state and decreasing the activity associated with weaker states (hence winner takes all). As known by those with skill in the art, the strength of the WTA algorithm may vary from none to one-step suppression, depending on the level of tolerance desired. Execution proceeds to step 408 wherein known causality (i.e., likelihood) statistics in NWT 102-7 are applied to the current state of the system to generate a predicted state of the object and/or its environment. That is, CE 102-6 will determine the likely future state of the object and/or its environment by applying known causality statistics to what is known about the current state of the object and/or its environment.

Execution proceeds to step 410 wherein a cost function as defined by the GCT 102-8 is applied to the predicted state of the environment. In step 412, the total predicted cost is calculated as a weighted sum of likelihood values determined in step 408, resulting in a total predicted future cost, given the current state of the environment.

Execution proceeds to step 414 wherein for each event (change in state) in the DSR 102-5, a hypothetical cost for an increase or decrease in that event is calculated. In other words, costs for other hypothetical possibilities in alternate internal states and alternate environmental events are calculated. In essence, this step reviews different hypothetical events or internal states within environment that will produce a reduction in costs for the currently predicted future.

Execution proceeds to step 416 wherein for changes that result in a decrease in projected costs, changes will be transmitted back to DSR 102-5 as a bias signal, thereby influencing future activity in SPE 102-1 and EGE 102-3. That is, the projected future is compared with the hypothetical future activity and associated, and if a hypothetical future has an improved reduced cost, the hypothetical future activity will be chosen and the event describing that hypothetical future will be transmitted back to the DSR 102-5. If there are no real changes that result in a decrease in projected cost, then no data is sent to DSR 102-5 and the system continues on its path with the current activity associated with the projected cost.

Execution proceeds to step 418 wherein CE 102-6 analyzes ongoing state data in DSR 102-5 to estimate likelihood statistics that represent values of strength that one event is the cause of another event using some form of Bayesian estimator or temporal difference learning algorithm as known to those skilled in the art. Any algorithm may be used that is able to identify patterns exhibited across temporal sequences of events as known to those skilled in the art. The duration of the temporal sensitivity may be varied to achieve an estimate of some combination of short-term likelihood statistics or long-term likelihood statistics, depending on the needs of the system. The algorithm is applied to information at DSR 102-5 in step 418 and results are applied to the NWT 102-7 in step 420.

Execution proceeds to steps 422 and 424 wherein these input weights are normalized and stored. Specifically, the weights are multiplied by a normalizing constant to make sure that the sum of the weights for a given event are reduced to the value of one (1) in order to reduce the set of weights to a proper likelihood function for that event, as known to those skilled in the art.

Execution continues and the process repeats continually in a loop as described above.

While the process steps in FIGS. 2-4 are described in the order above, those skilled in the art know that the order may be changed or steps may be added or deleted to achieve the desired outcome as described.

Examples of the process are described below.

The example process consists of a motor vehicle (car) with external sensors 104 capable of detecting obstacles in front of and lateral to the vehicle. The vehicle also contains two external motors 108 capable of moving the vehicle forward or steering the vehicle left or right. An array of internal sensors 106 indicates the speed and position of the two external motors 108, as well as the forward and lateral motion of the vehicle and changes in acceleration. Sudden decreases in acceleration are defined in the GCT 102-8 as having a high cost. In this example, external sensors 104 have detected an obstacle/object (another car) 10 feet away, directly in front of the system. Internal state sensors 106 indicate that the wheels are moving at 50 mph and the forward motor is engaged at 30%. All of these states are present in the DSR 102-5 at point 1 in time (i.e., processed by SPE 102-1 and transmitted to the DSR 102-5.) Now, one second later, the internal sensors 106 report a sudden change in acceleration as the two vehicles collide, the car wheels are no longer moving, and forward velocity is zero. External sensors 104 indicate that there is an object 0 feet away. These states of the car are also stored in DSR 102-5 at point 2 in time (i.e., processed by EGE 102-3 and transmitted to the DSR 102-5).

CE 102-6 will process both of those states as they occur (DSR 102-5) over the two points in time. CE 102-6 will determine that there is a high likelihood that the environmental conditions present at point 1 in time will likely lead to the outcome observed at point 2 in time, should they occur again. This conclusion is then stored in NWT 102-7. Should a similar sequence of events begin to occur in the future, CE 102-6 will predict, based on apparent causality knowledge now stored in NWT 102-7, that the events will be followed by significant cost in the form of sudden deceleration. Using this predicted cost, CE 102-6 will search for alternate states that do not result in such a significant cost, either by identifying lower cost or higher benefit alternatives. CE 102-6 will then project this alternate state back into the DSR 102-5 in an effort bias the system into an actual lower cost state. For example, given the same initial conditions, of an obstacle detected 10 feet directly in front of a moving vehicle, CE 102-6 may determine that engaging the turn motor will result in a lower cost as that new aggregate state (obstacle detected 10 feet away, forward velocity of 50 mph, wheels turned toward the left) has not produced a collision in the past. This change is projected to the DSR 102-5 and ultimately received by EGE 102-3, which then engages the turn motor, directing the vehicle to the left and around the obstacle ahead.

There are many applications for architecture 102. For example, architecture 100 may be used as a software solution for automatically and dynamically rebuilding a website without the need of a web developer. That is, architecture 102 may be used to redesign a website based on a web developer's definitions, constraints and requirements (e.g., maximum clicks on ads or links on a web page in a specified amount of time will cause a change in that page). In this respect, a web site becomes an artificial intelligence entity that can dynamically change itself to developer's needs and to achieve desired results without supervision or intervention.

In another example, system 100 with architecture 102 can be used in home automation. It can be implemented in a home to learn a user's behavioral characteristics to anticipate and control home automation such as when to make coffee, preheat oven or activate a heating or cooling system. There will be no need to broadcast this data to any external or internet-based data store (i.e., cloud), and no need to perform post hoc analysis of data in order for the system to achieve functionality. However, those skilled in the art know that cloud storage and/or processing may be used if desired with system 100 (particularly for the tables disclosed herein).

In another example, system 100 may be used in health monitoring (e.g., hospital, monitoring devices etc.) Architecture 102 may be used to collect and predict ongoing health data based on real time sensor readings. Architecture 102 may predict alarm states or intervene before a health issue becomes critical (learn set of data to generate alarms).

In another example, system 100 may be used in the context of a computer game to direct the behavior of non-playing characters or other computer-controlled entities. Architecture 102 may observe user behavior patterns and instruct non-playing characters to respond in idiosyncratic ways, customized to the particular user. In this example, the observed behavior patterns may also be extracted from the weight table 102-7 of the CE 102-6 and applied to the non-playing character. In this adaptation, the non-playing character would exhibit behavioral characteristics that mimic the observed user, allowing the user to interact with a statistically equivalent version of him or herself.

In another example, system 100 may be used in a motor vehicle to receive sensor data from a global positioning system, vehicle-mounted sensors (i.e. radar systems, video cameras or similar) aimed at the vehicle and/or the environment around the vehicle, and internal sensors reporting the state of the vehicle and driver. Architecture 102 may then observe visual data external to the vehicle and derive predictions about the future state of the vehicle, given internal sensor readings and the disposition of the driver. Architecture 102 may then interface with a network communication system, allowing it to communicate predicted traffic and road conditions to other vehicles in the communication area. Receipt of such transmissions would also allow architecture 102 to generate enhanced predictions about the state and goals of the connected vehicle as it navigated through the environment. To the extent that the vehicle is being operated autonomously, architecture 102 would enable the vehicle to learn from and interact with nearby vehicles, whether those nearby vehicles are autonomous or not. This example demonstrates the ability to interconnect different instances of architecture 102 by sending a subset of output from the EGE 102-3 or DSR 102-5 of one instance of architecture 102 into a subset of the input sensors of SPE 102-1 or DSR 102-5 of another instance of architecture 102.

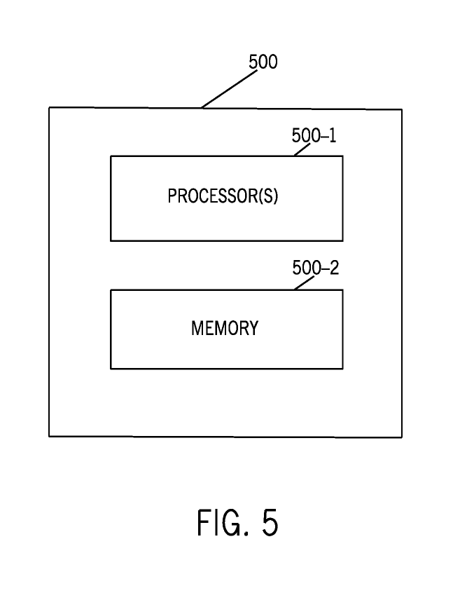

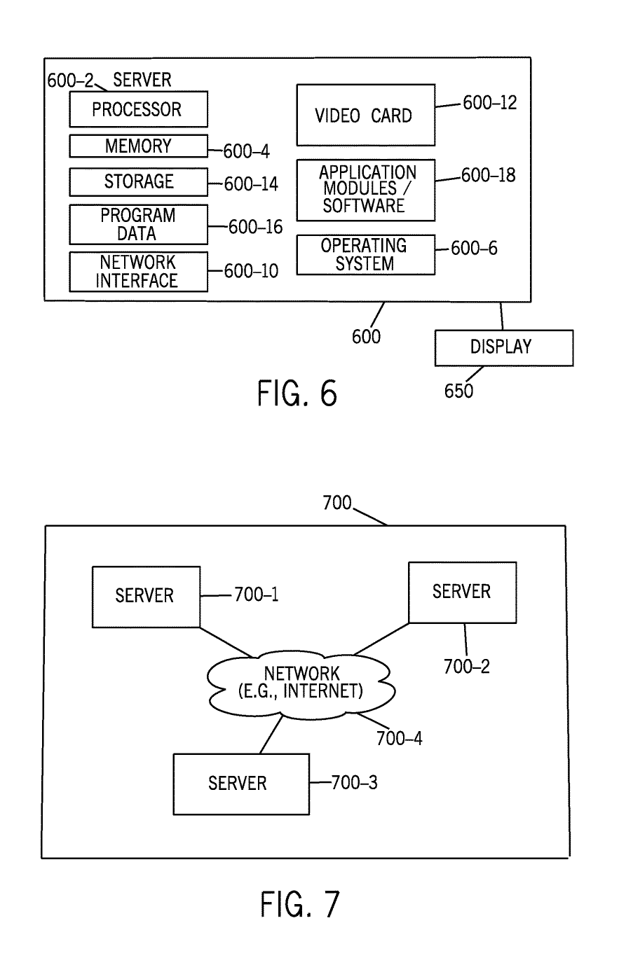

FIG. 5 depicts an example system 500 incorporating the architecture 102 in FIG. 1 depicting the salient hardware components. In particular, example system 500 incorporates one or more processors 500-1 and memory 500-2. Processors 500-1, as known to those skilled in the art, execute instructions stored in memory 500-2. Memory 500-2, as known to those skilled in the art, may include modules/instructions to be processed by processors 500-1. Memory may be volatile (e.g., RAM), non-volatile (e.g., flash or ROM) or other memory known to those skilled in the art. System 500 (i.e., processor(s) 500-1 and memory 500-2) may be a circuit board or card that is installed in a server (e.g., FIG. 6) or electronic device such as mobile device (e.g., smartphone) for example. Alternatively, system 500 may comprise one or more servers (described below) located at various places in the world, each connected to one another through a LAN and/or the Internet. The processor(s) 500-1 and memory 500-2 may be spread across these servers in a network. This is shown in FIG. 7.

FIG. 6 depicts example computer 600 that incorporates architecture 102. Specifically, FIG. 6 depicts a block diagram of a general-purpose computer to support the embodiments of the system and method disclosed herein. In a particular configuration, the computer 600 is a server (server 600) as described above or a personal computer. System 600 is configured to enable part or all of the process steps of the application/modules (software) in the embodiments described herein. The server 600 typically includes at least one processor 600-2 and memory 600-4 (e.g., volatile—RAM or non-volatile—flash or ROM). Memory 600-4 is coupled to and its stored contents are accessible to the processor 600-2 as known to those skilled in the art. In operation, memory 600-4 may also include instructions for processor 600-2, an operating system 600-6 and one or more application platforms 600-8 such as Java and a part of a software module/component or one or more software components/application modules 600-18. Server 600 will include one or more communication connections such as network interfaces 600-10 to enable Server 600 to communication with other computers over a network, storage 600-14 such as a hard drives for storing data 600-16 and other software described above, video cards 600-12 and other conventional components known to those skilled in the art. This server 600 typically runs Unix or Microsoft (or other operating system known to those skilled in the art) as the operating system and includes a TCP/IP protocol stack for communication over the Internet as known to those skilled in the art. A display 650 is optionally used.

FIG. 7 depicts another example system 700 incorporating architecture 102. System 700 includes servers 700-1, 700-2, 700-3 all connected to each other via network 700-4. For example, network 700-4 may include the Internet, one or more LAN(s) or both the Internet and one or more LAN(s)). Three servers are shown but those skilled in the art know that any number or servers may be used. Each server is typically the same as server 600 in FIG. 6 with the same components. The processors and memory may be distributed across these servers. Similarly, the architecture 102 software modules/instructions/tables (e.g., SPE 102-1, EGE 102-3, CE 102-6, and/or NWTs 102-2, 102-4, 102-7 and GCT 102-8 etc.) may be distributed across the same servers. For example, SPE 102-1, EGE 102-3, CE 102-6 may be stored and run on one LAN of a party while NWT 102-2, NWT 102-4 and NWT 102-7 may be stored on a user LAN of another party (linked by the Internet). In addition, any of the tables disclosed herein may be shared across networks in one or more systems.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A computer implemented method of providing an artificial intelligence architecture for controlling data and performing decisions relating to an object and/or an environment of the object, the method comprising executing on one or more processors the steps of:
processing data from one or more sensors to identify first and second states of the object and/or the object's environment;
analyze the first state and second state of the object and/or the object's environment to discover an apparent causal relationship between the first and second states of the environment; and
making a change to the data relating to an object and/or the object's environment based on the apparent causal relationship to affect subsequent states of the object and/or the object's environment.

2. The computer implemented method of claim 1 further comprising the step of storing first and second states prior to the analyzing step.

3. The computer implemented method 1 further comprising the step of storing the apparent causal relationship.

4. The computer implemented method of 2 further comprising the step of generating a predicted state of the object and/or the object's environment based on a current state of the object and/or the object's environment and the apparent causal relationship.

5. The computer implemented method of 4 further comprising the step of calculating a cost associated with the predicted state based on the apparent causal relationship and a weighted value related the predicted state of the object and/or the object's environment.

6. The computer implemented method of 5 further comprising the step of identifying a change in the first state and second state that yields a cost lower than the predicted calculated state.

7. The computer implemented method of 6, further comprising the step of, if a change in the first and second states is identified that yields a lower cost than the predicted calculated state, storing the first and second states for subsequent data control of the object and/or the object's environment.

8. The computer implemented method of 6, further comprising the step of, if the change does not yield a lower cost than the predicted state or no change in state is identified, the current state of the object and/or object's environment remains unchanged.

9. The computer implemented method of claim 1 wherein the causal relationship comprises a temporal relationship.

10. A system for providing an artificial intelligence architecture for controlling data and performing decisions relating to an object and/or an environment of the object, the system comprising:
(a) a data store to storing data relating to an object and/or the object's environment; and
(b) one or more processors coupled to the data store and programmed to:
(i) process data from one or more sensors to identify first and second states of the object and/or the object's environment;
(ii) analyze the first state and second state of the environment to discover an apparent causal relationship between the first and second states of the environment; and
(iii) make a change to the data relating to an object and/or the object's environment based on the causal relationship to affect subsequent states of the object and/or the object's environment.

11. The system of claim 10 wherein the one or more processors are programmed to store first and second states prior to the analyzing step.

11. The system of claim 9 wherein the one or more processors are programmed to store the apparent causal relationship.

12. The system of claim 11 wherein the one or more processors are programmed to generate a predicted state of the object and/or the object's environment based on a current state of the object and/or the object's environment and causal relationship.

13. The system of claim 12 wherein the one or more processors are programmed to calculate a cost associated with the predicted state based on the causal relationship and a weighted value related the predicted state of the object and/or the object's environment.

14. The system of claim 13 wherein the one or more processors are programmed to identify a change in the first state and second state that yields a cost lower than the predicted calculated state.

15. The system of claim 14 wherein the one or more processors are programmed to, if a change in the first and second states is identified that yields a lower cost than the predicted calculated state, store the first and second states for subsequent data control of the object and/or the object's environment.

16. The system of claim 15, wherein the one or more processors are programmed to, if the change does not yield a lower cost than the predicted state or no change in state is identified, the current state of the object and/or object's environment remains unchanged.

17. The system of claim 11 wherein the causal relationship comprises a temporal relationship.

18. The system of claim 10 wherein the causal relationship comprises a temporal relationship.

19. A system for using artificial intelligence in making decisions with respect to an object or the environment of the object, the system comprising:
(1) a data store for storing data relating to an object and/or the object's environment; and
(2) memory for storing a plurality of modules and one or more processors coupled the data store and the memory for executing a plurality of modules, the plurality of modules comprising:
a sensory processing engine for processing data from one or more sensors to identify first and second states of an environment; and
a causality engine for (1) identifying an apparent causal relationship between the first state and the second state and (2) making a change to affect subsequent states of the object and/or the object's environment.

20. The system of claim 19 wherein the modules further comprise an effector grammar engine that processes the data from the one or more sensors for identifying the object and/or the environment of the object.

21. The system of claim 19 wherein the apparent causal relationship comprise a temporal relationship.
